(19) United States
(12) Patent Application Publication
(10) Pub. No.: US 2026/0244941 A1
(43) Pub. Date: Aug. 20, 2026

(54) INTEGRATION OF FACT-CHECKED SYNTHETIC DATASETS WITH EXISTING DATA FOR ENHANCING AI-BASED DECISION MAKING IN DATA-SCARCE DOMAINS

(71) Applicant: NEC Laboratories Europe GmbH, Heidelberg (DE)

(72) Inventors: Timo SZTYLER, Heidelberg (DE); Lokesh SHARMA, Heidelberg (DE)

(21) Appl. No.: 19/159,339

(22) PCT Filed: Dec. 27, 2023
(86) PCT No.: PCT/IB2023/063275

§ 371 Date: Aug. 25, 2025

Related U.S. Application Data
(60) Provisional application No. 63/532,709, filed on Aug. 15, 2023.

(51) Int. Cl. G06N 3/096; G06N 3/0475

(52) U.S. Cl. CPC G06N 3/096; G06N 3/0475

(57) ABSTRACT

A computer-implemented, artificial intelligence (AI) method for integrating fact-checked synthetic datasets with existing data to support AI-based decision making includes generating synthetic data using an automated few-shot prompting mechanism with a generative AI model. The automated few-shot prompting mechanism comprises: feeding the model with a data schema of an existing database containing the existing data, feeding the model with a query language description with an instruction to generate a query for a missing feature from a database containing ground truth information, executing the generated query to obtain the ground truth information for training the model, and prompting the trained model to generate the synthetic data. The generated synthetic data is integrated with the existing data. The present invention can be used in a variety of applications including, but not limited to, several anticipated use cases in public safety, crime investigation and disaster risk management and medical/healthcare.

### CROSS-REFERENCE TO RELATED APPLICATIONS

This application is a U.S. National Phase application under 35 U.S.C. § 371 of International Application No. PCT/IB2023/063275, filed on Dec. 27, 2023, and claims benefit to U.S. Provisional Patent Application No. 63/532,709, filed on Aug. 15, 2023, the entire disclosure of which is hereby incorporated by reference herein. The International Application was published in English on Feb. 20, 2025 as WO 2025/037142 A1 under PCT Article 21(2).

### FIELD

The present invention relates to artificial intelligence (AI) and machine learning (ML), and in particular to a method, system, computer-readable medium, data structure with generated synthetic data and computer program product enhancing AI-based decision making in data-scarce domains through the integration of fact-checked synthetic datasets with existing data.

### BACKGROUND

The lack of training data for a machine learning model in various domains can make it impossible to apply machine learning in the data-scarce domains, or can result in inaccurate predictions, which cannot be safely relied on. The lack of training data is therefore a technical impediment to the effective use of machine learning in data-scarce domains.

### SUMMARY

In an embodiment, the present invention provides a computer-implemented, artificial intelligence (AI) method for integrating fact-checked synthetic datasets with existing data to support AI-based decision making. The method includes generating synthetic data using an automated few-shot prompting mechanism with a generative AI model. The automated few-shot prompting mechanism comprises: feeding the generative AI model with a data schema of an existing database containing the existing data, feeding the generative AI model with a query language description with an instruction to generate a query for a missing feature from a database containing ground truth information, executing the generated query to obtain the ground truth information from the database for training the generative AI model, and prompting the trained generative AI model to generate the synthetic data. The generated synthetic data is integrated with the existing data in the existing database. The present invention can be used in a variety of AI and machine learning applications including, but not limited to, several anticipated use cases in public safety, crime investigation and disaster risk management and medical/healthcare for prediction optimization.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates a method of generating a database and system architecture according to an embodiment of the present invention;

FIG. 2 schematically illustrates a method and system for automated few-shot prompting according to an embodiment of the present invention;

FIG. 3 schematically illustrates a method for geospatial linking and a geospatial linking module according to an embodiment of the present invention;

FIG. 4 illustrates a crime type landscape of an exemplary use case;

FIG. 5 illustrates crime solvability factor groups of the exemplary use case;

FIG. 6 illustrates a crime dataset construction framework according to an exemplary embodiment of the present invention for the exemplary use case;

FIG. 7 illustrates a synthetic crime dataset example of the exemplary use case;

FIG. 8 illustrates a data excerpt as a knowledge graph for the exemplary use case, in which the knowledge graph illustrates the data schema for burglary crime cases, including all relation types; and

FIG. 9 is a block diagram of an exemplary processing system, which can be configured to perform any and all operations disclosed herein.

### DETAILED DESCRIPTION

Embodiments of the present invention enable the generation of high-quality synthetic data that complements limited training data, leading to improved AI-based decision making in data-scarce domains. Embodiments of the present invention solve the technical problem of deploying accurate and reliable AI models in data-scarce domains. For example, embodiments of the present invention can be applied to a number of use cases in which the complementary synthetic data leads to improved AI-based decision making, and can be especially advantageously applied in domains with limited resources, such as being applied in an AI tool in law enforcement.

Embodiments of the present invention provide solutions to the technical problem of how to generate an accurate and reliable AI model in the case of little training data, including limited representations, lack of contextual understanding, and the difficulty in handling rare events. The technique employed by embodiments of the present invention provides to maximize the utility of the available data and to improve the performance of the AI model and downstream task.

The issue of little training data can be observed in several technical domains, including, but not limited to digital medicine and personalized or automated health care, drug, composition and material development, financial service tools, and earth science-related tools (e.g., relating to natural disasters), as well as law enforcement tools, which is used as an exemplary application herein. Embodiments of the present invention therefore enable to effectively apply AI in a number of technical fields, having the advantage to improve the efficiency, decision making, and the safety and risk mitigation, among other improvements to the downstream tasks provided as a result of the improved decision making. In fact, in some domains with particularly limited data, embodiments of the present invention enable AI-based decision, which was not possible with existing technology.

In contrast to approaches used in existing technology such as transfer learning, the approach according to embodiments of the present invention already addresses the issue at the dataset level by focusing on the quality, diversity, and size of the training data itself. Rather than relying solely on pre-existing knowledge or models, embodiments of the present invention recognize the importance of having a robust and comprehensive dataset that captures the necessary variations and nuances of the problem domain. The approach according to embodiments of the present invention involves data collection and augmentation techniques to ensure a representative and diverse dataset that encompasses a wide range of scenarios, edge cases, and rare events.

Embodiments of the present invention provide an approach to construct a POLE-based database, storing multi-modal datasets. The approach overcomes the technical problem of how to build and link the nested key-value-based database. According to an embodiment, the approach also overcomes the technical problem of how to organize the data records between the system memory and the hard-disk for efficient access. Further, embodiments of the present invention provide solutions to the technical problem of how to enable automatic, AI-based decision making (computer-implemented function) in situations with little data (e.g., crisis management situations).

POLE stands for People, Objects, Locations, and Events. It is a schema used to classify and organize information or data based on these four key elements. People usually refers to individuals, whether they are real or fictional. Objects encompass physical or virtual entities that exist in the world. Locations represent specific places or geographical points of interest. Events refer to occurrences or happenings in a given context. By organizing data into these four categories, it becomes easier to analyze, search, and understand the relationships and connections between different elements within a dataset.

In a first aspect, the present disclosure provides a computer-implemented, artificial intelligence (AI) method for integrating fact-checked synthetic datasets with existing data to support AI-based decision making. The method includes generating synthetic data using an automated few-shot prompting mechanism with a generative AI model. The automated few-shot prompting mechanism comprises: feeding the generative AI model with a data schema of an existing database containing the existing data, feeding the generative AI model with a query language description with an instruction to generate a query for a missing feature from a database containing ground truth information, executing the generated query to obtain the ground truth information from the database for training the generative AI model, and prompting the trained generative AI model to generate the synthetic data. The generated synthetic data is integrated with the existing data in the existing database.

In a second aspect, the present disclosure provides the method according to the first aspect, wherein the automated few-shot prompting includes an iterative process to teach the generative AI model to determine semantic relations prior to generating the synthetic data, the iterative process comprising: preprocessing the existing data to generate an incomplete record by removing a feature that is derivable from other features; feeding the incomplete record to the generative AI model with an instruction to fill in the removed feature; and training the generative AI model using feedback on whether the generative AI model provided a correct response to the instruction to fill in the removed feature.

In a third aspect, the present disclosure provides the method according to the first or second aspect, wherein the automated few-shot prompting mechanism includes an iterative process to teach the generative AI model to correctly generate the query prior to generating the synthetic data, the iterative process comprising: passing the generated query to a query language parser; and training the generative AI model using feedback on whether the generated query contains errors in query syntax.

In a fourth aspect, the present disclosure provides the method according to any of the first to third aspects, wherein the automated few-shot prompting mechanism includes instructing the generative AI model to provide an answer to the query and checking the answer for correctness by comparing the answer to the ground truth information, and wherein the training the generative AI model is performed by prompts that inform the generative model of the ground truth information in a case it is determined that the answer is different from the ground truth information.

In a fifth aspect, the present disclosure provides the method according to any of the first to fourth aspects, further comprising extending the existing database by extracting facts from text data sources using natural language processing techniques.

In a sixth aspect, the present disclosure provides the method according to any of the first to fifth aspects, further comprising enhancing connectivity of records in the existing database by geospatial linking.

In a seventh aspect, the present disclosure provides the method according to any of the first to sixth aspects, wherein the geospatial linking comprises: computing a polygon around an event location based on a given network; querying potential points of interest within the computed polygon to determine pairs of locations that are stored as key-value pairs in a key-value database; computing a shortest path to a nearest neighbor based on the given network; aggregating line segments of the given network into an aggregated value based on the shortest path; and hashing the aggregated value and storing the hashed aggregated value as a key-value pair in the key-value database.

In an eighth aspect, the present disclosure provides the method according to any of the first to seventh aspects, wherein the polygon includes an additional buffer size for scalability to a new location located adjacent to the polygon.

In a ninth aspect, the present disclosure provides the method according to any of the first to eighth aspects further comprising swapping data contained in the existing database between memory and persistent storage based on the geospatial linking such that subsequent queries involving geospatially linked locations are processable with a higher computational speed based on relevant data for the subsequent queries being stored in the memory.

In a tenth aspect, the present disclosure provides the method according to any of the first to ninth aspects, further comprising collecting information for building the existing database with the existing data from a sensor network, the sensor network including physical sensors that record information and virtual sensors that convert the recorded information to People, Objects, Locations, and Events of the data schema.

In an eleventh aspect, the present disclosure provides the method according to any of the first to tenth aspects, wherein collecting the information for building the existing database includes querying the sensor network for the People, Objects, Locations and/or Events that are related to an entity of interest, and storing relationships determined by the querying in the existing database.

In a twelfth aspect, the present disclosure provides the method according to any of the first to eleventh aspects, further comprising using the existing database containing the synthetic data and the existing data to train an AI model for a downstream machine learning task.

In a thirteenth aspect, the present disclosure provides the method according to any of the first to twelfth aspects, wherein the downstream machine learning task is a prediction of an area to be observed and/or resources to be allocated for public safety or disaster management.

In a fourteenth aspect, the present disclosure provides a computer, artificial intelligence (AI) system for integrating fact-checked synthetic datasets with existing data to support AI-based decision making, the system comprising one or more hardware processors which, alone or in combination, are configured to provide for execution of the method according to any of the first to thirteenth aspects.

In a fifteenth aspect, the present disclosure provides a tangible, non-transitory computer-readable medium for integrating fact-checked synthetic datasets with existing data to support AI-based decision making, the computer-readable medium having instructions thereon which, upon being executed by one or more hardware processors, alone or in combination, provide for execution of the method according to any of the first to thirteenth aspects.

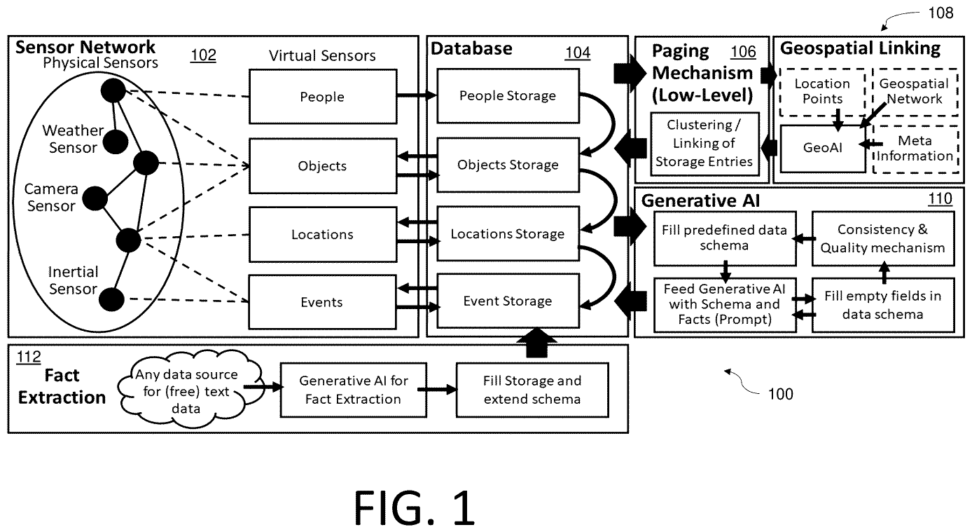

FIG. 1 illustrates a system architecture 100 according to an embodiment of the present invention. The main components are a sensor network 102, a database 104, a fact extraction component 112, a paging mechanism 106, a geospatial linking component 108 and a generative AI component 110. The following describes these components and how they are connected.

The sensor network 102 includes a physical and a virtual sensor network. The physical sensor network is an infrastructure composed of various types of sensors, such as weather sensors, inertial sensors and cameras. These sensors are distributed across a designated area or city, forming a network that collectively captures and monitors different aspects of the environment. The data collected from these sensors can be transmitted wirelessly or through wired connections to a central system or server for processing and analysis. The virtual sensors, embedded in the central system, transform the captured signals from the physical sensors into representations of people, objects, locations, and events that are stored in the database 104. For example, virtual sensors can analyze the visual data captured by cameras and perform object analysis to identify and classify different objects. It is advantageously provided that the sensor network not only records or captures the information, but also employs an entity linking mechanism. For instance, if the virtual event sensor records an event (e.g., a car accident), stored in the event storage database, this has a direct influence on the physical sensor network in terms of recognizing related people, objects, and locations. It is doing so by, for example, relying on the geolocations of the sensor which captured the event, to link the recorded event, to locations, people, and objects which are nearby as captured by nearby sensors. Entity linking could be performed using similarity scores such as the cosine value of entity representations. Virtual sensors, when classifying an entity to be an event (e.g., car accident) that is a known entity in the entity storage, could trigger the physical sensor to collect additional people, location, object and/or event information by feedback loops. The virtual sensors could implement AI models to identify people, objects and locations for the entity linking (e.g., using image classification).

The fact extraction component 112 extends the sensor network 102 to the virtual world. In particular, the fact extraction component 112 is a component designed to use relevant information from a real sensor network to query appropriate protocols and application processing interfaces (APIs), for example on the Internet or any other available data source. The retrieved information is processed using natural language processing (NLP) techniques (e.g., generative AI) to extract meaningful facts and knowledge. This involves tasks such as named entity recognition, entity linking, or sentiment analysis to identify and categorize important information. The extracted facts are then loaded into the database 104, and subsequently linked with the original sensor data. The fact extraction component 112 is designed to continuously extract facts, and to refresh the database 104 with the latest information available (e.g., on the Internet). The fact extraction component 112 implements a function to extend existing entities in the database 104. Those entities originally result from the sensor network 102. Thus, these entities are part of the query or question sent to the fact extraction component (e.g., part of a query to the generative AI model). As such, a link to the entity is provided since the answer belongs to the entity which was part of the question.

The generative AI component 110 exploits the facts stored in the database 104 (gathered from the sensor network 102, and the fact extraction component 112) to enable automated few-shot prompting. In particular, the recorded facts from the sensor network 102 and the predefined POLE schema of the database 104 are provided to the generative AI component 110. In an iterative process, the generative AI component 110 fills the missing fields of the schema, which are checked for consistency and quality. If they are accepted, they are added to the database, if they are rejected, the prompt query is refined and the process repeats. In particular, embodiments of the present invention provide technical means for how the prompt query is generated, and how the quality of the answer is evaluated. Few-shot prompting describes the process of demonstrating to the model the type of expected outcome which should steer the model to better performance. Usually, this is done in a human-computer interaction process. In contrast, embodiments of the present invention provide to fully automate this process, thereby enhancing the computer functionality and improving speed and efficiency both in terms of physical/personal and computational resources.

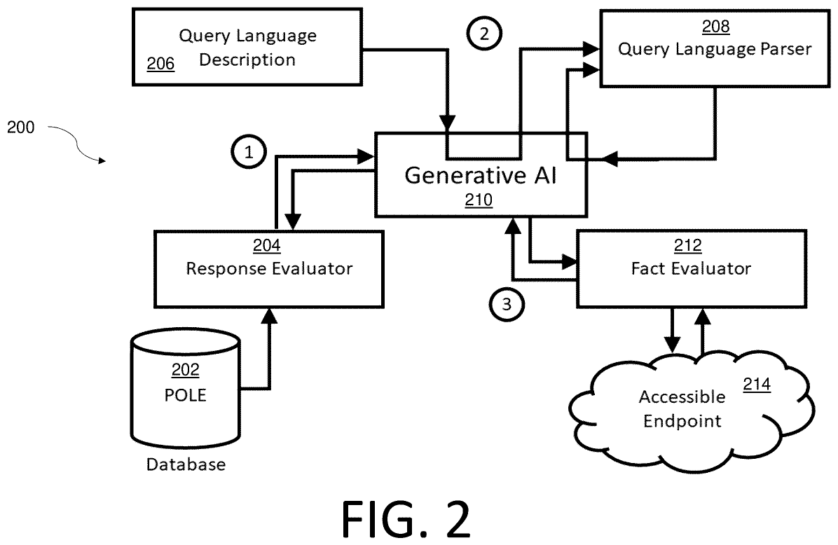

FIG. 2 illustrated the process of automated few-shot prompting according to an embodiment of the present invention.

In a first step, the generative AI model is fed with the database schema (POLE), and then, in an iterative process, the generative AI model is fed with database records. Those records are preprocessed in a way that certain features are removed from a record, but only those which can be directly derived from other feature values. For example, a record about a location might have features like latitude, longitude, country. Removing the country would not be an issue as this feature can be reconstructed from the latitude and longitude. The incomplete record is fed to the generative AI model, along with the instruction to complete it. An incorrect response can be immediately detected, and the generative AI model can be informed that it is wrong and why, and use this feedback as training data to improve its performance. This step ensures that the AI model captures the correct relations among the features.

Feeding the schema includes providing some meta information to the model such that it can understand the data structure and get some context of the input data. The schema is sufficient enough for the model to know the domain and range of the POLE entities. The model is instructed/trained iteratively based on its capability to predict the next word concept (probability). If the prediction is wrong, suitable error messages are provided to the model as prompts and the model predicts again until it makes a correct prediction. The records are stored, for example, in a not only structured query language (NoSQL) database as key-value pairs, which is flexible enough to represent a POLE structure. The relationships between the POLE entities are stored, for example, as a list of triples and can also be saved as pointers to a memory address. Thus, although the people, objects, locations and events can be stored separately, they are not isolated in that there are links/relations among those separately stored or categorized data sets.

In a second step, the generative AI model is fed with a query language description (e.g., structured query language (SQL) or SPARQL). The model can potentially communicate with any (third-party) database or API. For that, (prompt) the generative AI model is taught through prompts the query language definition/description. This could include some official documents (e.g., for SQL). This helps the generative AI model to understand what are valid queries. The model applies that training to generate queries to communicate with the (third-party) database. Thus, free text is fed to the generative AI model to perform prompting to guide the model. The generative AI model is thereby instructed to generate valid queries for actually missing features in the database. The generated queries are passed to a query language parser. Errors in the query syntax are fed back to the generative AI model. This is an iterative process that continues until the generative AI model generates queries with a predetermined or desired level of quality. The syntax errors are detected by executing the queries. The error message combined with the available query language documentation allows to (automatically) prompt the model to fix the issue in the generated syntax. The query language also can handle semantic errors in that the returned answer should be in an expected/specific format. This structured information should be combined with existing information stored in the database. Semantic errors can then be detected if there is a mismatch (e.g., when fusing the structured data). These procedures lead to a sufficient level of quality. Alternatively or additionally, the query language parser can operated for a number of iterations (corrections), which also provides an indicator of the quality of the generated queries and answer.

In a third step, the generated queries are actually executed. However, before executing the query, the generative AI model is instructed to provide the actual answer of the query (i.e., it fills the real missing fields in the database records). Executing then the query allows to check if the answer of the generative AI model is correct. If the answer of the AI model is wrong, the response from the query (e.g., to WikiMedia) allows to correct and update the generative AI model so that it behaves as expected. As a final step, the generative AI model can then be used to generate synthetic data to expand the real data.

In the first part, when the generative AI model (e.g., an LLM) itself is instructed to answer the query, it only relies on the knowledge which is embedded in the model. In the second part, when the query is executed, the generated query is actually sent to a different (e.g., external or third-party) database. Since the process uses different knowledge bases (the one from the AI model, and the third-party database), the answers can be different in the first part and in the second part. The assumption is that the answer from the third-party database is correct and is used as ground truth. If the generative AI model answers differently, then it is determined that the model made a mistake and the model is accordingly taught (with prompting) that it was wrong and what is correct. The third-party database can be, for example, WikiMedia. The generated query, and the answer to the query are part of steering the model and teaching the model to perform accurately. Once this is done, the query part is skipped and the model answers directly all questions, thereby filling in the missing gaps.

An advantage of combining real and artificial data is that it limits the disadvantages of using just artificial data and enables AI-based decision making for use cases where not enough real data is available. By leveraging factual knowledge and existing schemas, the generation of artificial data can yield datasets that are characterized by realism, diversity, and variability. Such datasets can be effectively employed across a wide array of domains and applications. Moreover, combining real and artificial data also enables to approximate simulations.

Referring again now to FIG. 1, the database paging mechanism 106 is a technique employed to optimize data querying by efficiently managing the movement of data between memory and the hard disk. The paging mechanism 106 incorporates an intelligent decision-making process based on the connectivity within the database 104 and the current context. The connectivity information could be stored as a specific key-value pair. For example, the key could be ‘rels’ and the value could be a list of memory addresses that point to different entities. The current context refers to the data record which is under observation/processing. If the context is generating synthetic data, then the current record is the one which the generative AI model is being asked to complete. The movement of data between memory and hard disk occurs in a dynamic manner, guided by specific conditions. When a query is executed, the database system assesses the data connectivity and determines which data pages are most likely to be accessed or modified. These pages are then prioritized for loading into memory, while less frequently accessed or modified pages may be swapped out to the hard disk. The decision on when to move data is influenced by the geospatial connectivity in the database. When a query is executed, the database system analyzes the geospatial relationships between the data records and determines which pages are most relevant for the current query. These pages, which contain the data records that are spatially connected or related to the query, are prioritized for loading into memory. Hence, the decision on which pages to load into memory is based on factors such as the proximity of the data records to the queried location, the spatial extent of the query, and the connectivity patterns within the geospatial dataset. Pages that are likely to contain data relevant to the query, either due to their direct proximity or their connection to other queried data records, are selected for memory loading. By prioritizing the loading of data pages that are spatially connected or related to the query, the paging mechanism 106 reduces the amount of disk input/output (I/O) operations required. This leads to faster query response times as the relevant data is readily available in memory, minimizing the need to access the slower hard disk. Accordingly, embodiments of the present invention provide for improving compute speed and power and conserving computational resources.

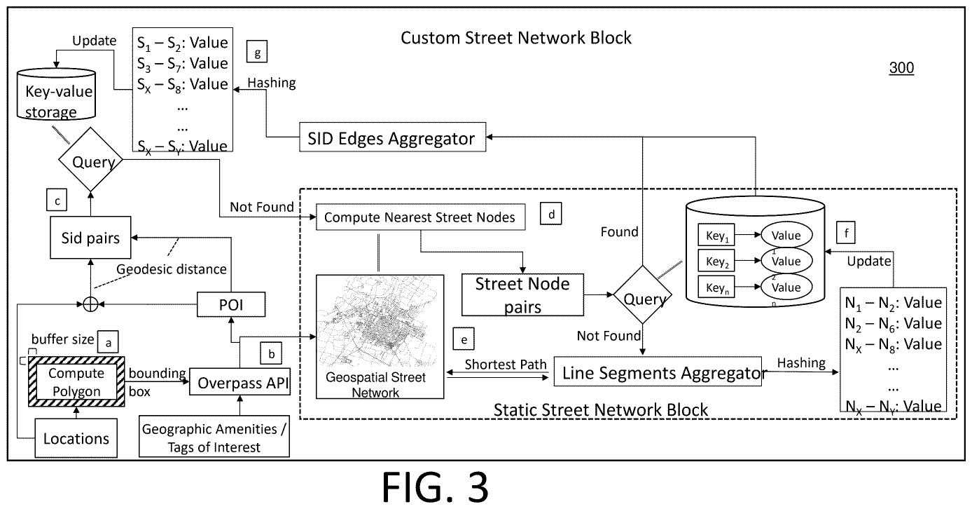

The geospatial linking component 108 applies a method to link data in the database 104 through geospatial characteristics. The method involves creating two types of networks: 1) a base static network with nodes representing coordinates (e.g., on streets) (see FIG. 3, box f) and a custom street network with nodes (e.g., representing the point-of-interest or event locations) (see FIG. 3, key-value storage). Each street network is a composition of line segments/edges (represented as “source node id-target node id”) and is stored in the POLE database (see FIG. 1) using a hashing mechanism. Two (geo-)locations are connected if they meet two conditions: 1) the geodesic distance between the locations is less than a threshold value, and 2) there exists an actual network (e.g., streets) between both locations.

The database (see FIG. 3, box g) contains line segments, where each entry has a unique identifier to query source and target node ids, and the value holds aggregated information about the actual network (e.g., street) connections. Embodiments of the present invention provide to create a weighted graph structure by using these entries to connect any two geolocations. This system allows for efficient querying when connecting, for example, event locations to points of interest or connecting two points of interest with each other. Only if such a query is not found in the existing database, the system queries an external API to compute such a connection.

FIG. 3 illustrates a geospatial linking module 300 and method for geospatial linking according to an embodiment of the present invention in detail. Given a list of event locations, a polygon is computed and extended by a buffer size on its perimeter for scalability reasons (FIG. 3, box a). Computing a polygon is a mathematical calculation that takes as input a list of coordinate pairs and outputs a polygon as four coordinate pairs denoting North-East-South-West directions, for example using an existing open source package. Selection of buffer size is a design choice which can be determined by an experimental process that depends on hardware limitations and the accuracy required, and can also depend on the particular application. The computed bounding box/polygon is used to query all possible points of interest (FIG. 3, box b). Querying points of interest can done via the Overpass API. Specific GraphQL queries are constructed according to the official documentation and information is thereby queried. The custom street network includes line segments connecting each point of interest (POI) to every other POI if they satisfy the mentioned criteria. There are publicly available data sources such as Open Street Map which contain such information. Additionally, each event location is connected to every possible POI. A stacking operation is used to compute and store these “pairs of locations” as key-value pairs, with NULL as their initial value (FIG. 3, box c). Unique identifiers for location pairs are created in an incremental manner. If a unique identifier is not found in the existing database, the “Static Street Network Block” is triggered, which computes the nearest geographic coordinates on the street network to source and target nodes respectively (FIG. 3, box d). In other words, the source and target nodes are two different coordinates where a route is to be computed. The distance is computed to assess if they should be connected each other in the first place. If the total distance is below a threshold it is assumed to be in proximity and is treated as an edge; otherwise not. These geographic coordinate pairs (nearest neighbors) are used to query another database, and if no value is found, a shortest path is computed (FIG. 3, box e), for example, using a feature from the Overpass API. The shortest path is used to aggregate the small line segments into a single value representing the path between the geographic coordinate pairs (nearest neighbor pairs). The aggregated value is hashed and stored as a key-value pair as a different collection/table in the database (FIG. 3, box f). The final aggregated value along with additional properties, such as distance to neighboring street coordinates, are stored in the database (FIG. 3, box g). In the event of new event locations and new POI tags, the querying is not extensive, and only the difference (new pairs of locations) goes through the pipeline, saving computational time, power and resources.

One of the improvements over existing technology of the geospatial linking according to embodiments of the present invention is provided for by the logic of how the polygon/area is computed with an additional buffer size for scalability reasons (such that if a new location is added right next to the boundary of existing polygon, the base static street network calculation is not required). Since the additional buffer size provides to always consider an extra area, the distance to POIs outside the initial polygon also gets computed. Later, when the area of polygon shifts, it is not needed to compute distances to POIs that were close enough to the boundary/buffer size. In addition, the architecture also connects two geolocations with each other with a caching mechanism. Specifically, the street path could be similar for two different pairs of locations, and if such a path/line segment was previously computed and stored in a special storage, it could be directly looked up, thereby providing for further savings of computational time, power and resources.

Embodiments of the present invention thus provide for general improvements to computers in machine learning systems not only to be able to supplement limited training data to enable or improve an AI-based decision-making tool for a machine learning task, while improving accuracy and performance and saving computational time, power and resources. Moreover, embodiments of the present invention can be practically applied to use cases to effect further improvements in a number of technical fields including, but not limited to, medical (e.g., digital medicine, personalized healthcare, AI-assisted drug or vaccine development, patient treatment, etc.), smart cities, forensic tools, material development, area monitoring, public safety, digital government (e.g., case management), etc., and especially those applications where limited actual data is available. In some applications or use cases, embodiments of the present invention can apply analogously to different data schema other than the POLE schema.

In an exemplary embodiment, the present invention can be applied to an automated forensic tool for public safety: crime investigation—collecting. With respect to this use case, having resources in policing is crucial as there are not enough resources for all crime cases. They have essentially a limited budget in terms of resources (e.g., personnel and evidence collection devices) and need (forensic) tools to extend their capacities, or to enable that one police officer can do the work of two or more. Embedding the approach according to an embodiment of the present invention in a forensic tool allows to overcome the issue of limited data and enable or improve AI-based decision making. Especially in specialized or emerging areas, forensic investigations often suffer from limited available data. For instance, the forensic tool could automatically leverage from domain knowledge, or link the current case to historical cases. In addition, the forensic tool could be tested with the synthetic data. This can help identify potential limitations, uncover vulnerabilities, and improve the tool's performance in handling complex or uncommon forensic cases. The output of the system can be used to control other technical devices, e.g., those that collect the evidence, or those that need to be calibrated (e.g., AI-based solutions). In this use case, the data source can include available sensor networks (e.g., camera, weather station, and presence sensors), (smart) forensic tools (if available), the database of the police force (e.g., past crime case records), socio-demographic information (e.g., characteristics of the social life in the district of interest), etc. Application of the method according to an embodiment of the present invention uses facts of the case of interest, along with a data schema which fits the case, to provide for synthetic data generation and geospatial analysis to enrich facts with realistic data and improve data record linking. The enriched data can then be utilized to enable improved AI-based solutions, such as decision-making algorithms. The system outputs fact-checked synthetic datasets backed with existing data, stored in a database. As automated actions or technicity, the output of the system can directly be used to control (forensic) resources such as drones, androids, or cameras (e.g., body-cameras). These can be used for scouting or observing certain areas, or to redirect traffic. In particular, the output of our system can control these resources to instruct them on which areas they need to focus. This is especially advantageous in scenarios with time constraints.

In another exemplary embodiment, the present invention can be applied to an automated monitoring tool for disaster risk management (e.g., monitoring of areas at risk). With respect to this use case, an advanced hotspot identification model allows remote surveillance (e.g., CCTV and drones) at street intersections, and also to observe and manage wide areas. In particular, forecasting the development of disaster-prone areas and the determination of locations where certain resources or monitoring units are or will be required can increase the effectiveness and efficiency of post-disaster assistance. Further, predicting the potentially required resources depending on the sort of damage or situation, and the resource availability in that region supports resource management and decision makers. In the context of disaster risk management, where each disaster event is unique and data may be scarce or incomplete, training AI models becomes especially technically challenging. Limited data can lead to bias, reduced model performance, and inadequate predictions, hindering effective decision-making and response efforts in mitigating and managing disasters. In this use case, the data source can include available sensor networks (e.g., camera, weather station, and presence sensors), the database of the respective institute (e.g., past case records), sociodemographic information (e.g., characteristics of the social life in the district or area of interest), and road networks. Application of the method according to an embodiment of the present invention uses facts of the case of interest, along with a data schema which fits the case, to provide for synthetic data generation and geospatial analysis to enrich facts with realistic data and improve data record linking. The enriched data can then be utilized to enable improved AI-based solutions, such as decision-making algorithms. The system outputs fact-checked synthetic datasets backed with existing data, stored in a database. As automated actions, or technicity, the output of the system can be directly used to enable AI algorithms to optimize the distribution and control of limited resources such as drones, androids, or cameras. These can be used for scouting or observing certain areas, and also for smart routing of traffic (e.g., to avoid certain areas by controlling lights or barriers). Further, an alarm light or siren could be automatically activated if the risk in a particular area increases suddenly (e.g., similar to the situation of alarms close to the ocean which indicate that a storm is approaching).

In an embodiment, the present invention provides a method for enhancing AI-based decision making in data-scarce domains through the integration of fact-checked synthetic datasets with existing data, the method comprising the steps of:

1) Collect information through a sensor network about People, Objects, Locations, and Events (see FIG. 1, Sensor Network) to build a POLE database which includes or is associated with relationship information among the People, Objects, Locations, and Events. In some cases, a POLE database may already exist (e.g., existing police case management systems).
a. The sensor network recordings are converted through virtual sensors to people, object, location, and event records.
b. First, the entity of interest (e.g., People) is gathered. Then, objects which related to the entity of interest are obtained from the sensor network. Analogously, it is performed to obtain locations which related to the objects, and then events which relate to the locations. As soon as the sensor network records a new event (or signal), a new record in the database is created or an existing one is updated.
   2) In some implementations, use the fact extraction module to query data from the virtual world (see FIG. 1, Fact Extraction).
a. For each captured People, Objects, Locations, and Events record, free text information is crawled.
b. Then, a generative AI model converts the crawled information into structured information and links them to the original record.
   3) Extend the collected data with synthetic data by leveraging the generative AI model with an automated few-shot prompting mechanism (See FIGS. 1 and 2).
a. Teach the generative AI model the semantics of the features. This is an iterative training process where the AI model is instructed to complete a removed/known feature, and is given feedback on whether it filled in the missing information correct.
b. Teach the generative AI model to generate proper queries for a given endpoint (the information endpoint, for example DBpedia or WikiMedia, from where the fact is being retrieved).
c. Teach the generative AI model the facts by comparing the generated output and the queried information. This is an iterative training process and provides a prompting mechanism which corrects the model behavior (see FIG. 2). The queried information from a database is the fact (ground truth), whereas the generated output is the answer of the generative AI model. If the model works perfectly, then the queried information and the generated output are the same; however, this is usually not the case. Hence, if the generated output and the queried information differ, then the generative AI model is taught the true information (through prompting).
   4) In the background, in some implementations, use an intelligent decision-making process for swapping data to the hard-disk or keeping in memory based on the (geospatial) connectivity within the database (see FIG. 1, POLE database 104, and step 5) below).
   5) In some implementations, enrich the connectivity of the data records in the database through geo-spatial network analyses (see FIG. 3).

Embodiments of the present invention provide for the following improvements and technical advantages over existing technology:

1. Providing for automated generative AI prompting for generating fact-checked synthetic datasets through the combination of (see step 3) above):
a. Schema-guided data imputation to enable semantic understanding of the features.
b. Use of a query language parser to teach the model iteratively the query generation.
c. Then, use of the model-guided query generation to query structured facts in order to assess and potentially correct the answer of the generative AI model. The model generates a database query as the model-guided query generation. The query is sent to a pre-selected database such as a publicly available database like DBpedia or any internal, e.g., case management database. The answer to the query is in a structured format and it is assumed that the information stored in these databases (e.g., DBpedia) are facts (i.e., correct). As such, the answer to the query provides the ground truth.
   2. Leveraging from the geospatial relationship of the data records in the database to swap data between the memory and the persistent storage for a database management system (see step 4) above).
a. This enables that subsequent queries that involve nearby locations can be processed quickly since the required data is already in memory.
b. Further, the database's memory management component exploits the geospatial hash value to avoid that the memory is overloaded due to a dense geospatial location. It is doing so by uniform selection across the People, Location, Object, and Event storage. The hash values are close in distance in Euclidean space if the related objects in the real world are close (from a geospatial point-of-view). This provides for increased computational efficiency by mainly loading records which are close, and therefore more relevant to the specific record being looked at. Uniform selection refers to not prioritizing any record type and instead treating People, Objects, Locations, and Events equally.
   3. Providing for geospatial database linking by computing polygons based on a given network, and incorporating an additional buffer size to enhance scalability.
a. The aggregated value is hashed and stored as a key-value pair as a different collection in the database, enabling for efficient querying when connecting two data records.
b. The hash value represents the location information. This hash value is designed in such a way that it encodes the spatial coordinates of the record.

Additionally, the distance between different hash values in an n-dimensional space corresponds to their actual distance in the real world, based on a specific network configuration.

The existing AI technology for working with limited training data involves various techniques and approaches. One common approach is transfer-learning, where a pre-trained model on a large dataset is fine-tuned on a smaller dataset. While transfer learning can be effective in leveraging pre-trained models, it does not always transfer well to the target domain. The pre-trained model may have learned biases or features that are not relevant to the target task, leading to suboptimal performance.

Another technique is data augmentation, which involves generating additional training samples by applying transformations or perturbations to existing data. Although data augmentation can increase the size of the training set, it can introduce unrealistic or irrelevant variations to the data. This can potentially mislead the model and affect its generalization ability.

Active learning is also employed, where the model actively selects the most informative samples to annotate and train on. Implementing active learning requires human involvement to label the selected informative samples. This process can be time-consuming and costly, both in terms of human and computational resources, especially when dealing with large datasets or complex tasks.

Domain adaptation techniques aim to bridge the gap between the source and target domains. However, the success of domain adaptation heavily depends on the similarity between the domains. If the domains are significantly different, the performance of the adapted model may still be limited.

In contrast, embodiments of the present invention introduce technology that is able to combine facts, and provide for a predefined schema (POLE), data linkage, and a generative AI model, and provides for a number of improvements over the techniques used by existing technology, especially when working with limited training data. In particular:
Fact-based: By incorporating information, such as domain knowledge or expert insights, into the model, embodiments of the resent invention improve the accuracy and relevance of the generated data.
Predefined schema: Having a predefined schema provides a structured framework for generating synthetic data.
Data linkage: Linking datasets allows for the creation of richer and more informative feature representations.
Generative AI model: Utilizing a generative AI model allows for the creation of new data instances that closely resemble the characteristics and distribution of the real data.

Overall, this approach according to embodiments of the present invention provides a robust framework for generating high-quality synthetic data that complements the limited training data, leading to improved AI-based decision making in data-scarce domains.

In the following, further background and description of exemplary embodiments of the present invention, which may overlap with some of the information provided above, are provided in further detail using a description of an associated inventor research article written earlier and forming a part of the present disclosure. Further developments relative to the following description are already described above. To the extent the terminology used to describe the following embodiments may differ from the terminology used to describe the preceding embodiments, a person having skill in the art would understand that certain terms correspond to one another in the different embodiments. Features described below can be combined with features described above in various embodiments. In particular, the following includes a detailed description of an exemplary embodiment for AI-supported crime solvability.

Policing encounters the pervasive issue of tight resources, posing challenges in effectively handling all demands. With the goal of predicting the investigative success, AI-based crime solvability can not only facilitate the early release of resources, but also improve the efficiency of a police officer. Current research on AI-based crime solvability is centered around analyzing elements that impact the probability of solving a crime. However, the progress in this field is often hindered by the restricted accessibility, non-uniformity, and limited availability of datasets. To overcome this issue, an embodiment of the present invention provides a modular framework that assembles a comprehensive crime dataset by aggregating, linking, and harmonizing information from multiple data sources.

This is supplemented by an exhaustive literature study on factors for predicting solvability for various crime types. Furthermore, the applicability of the AI framework according to an embodiment of the present invention is showcased by presenting an exemplary, real-world use case for crime solvability. This is accomplished by constructing a knowledge graph and utilizing node classification to predict solvability scores for crime cases. It is also discussed how an embodiment of the present invention can utilize Large Language Models (LLMs) for crime solvability research, while examining the advantages of such use of LLMs.

Crime solvability addresses the issue of understanding the likelihood of solving a crime case at different stages of the investigation process. As an active research area in law enforcement, researchers focus on how to ascertain and leverage solvability in order to support law enforcement agencies in their daily operation. In recent years, remarkable progress has been made in the domain of AI algorithms, particularly with regard to advancements in explainability and the ethical dimension. Considering the development of AI laws such as the European AI Act, these advances have significantly increased the applicability of AI algorithms in the public domain. Consequently, new avenues for decision-making in policing have emerged, with AI algorithms having the potential to contribute to crime resolution and prevention.

A technical problem of many existing studies on the subject is that they are limited in respect of data, transparency, and reproducibility. Embodiments of the present invention overcome this and two related technical challenges. The first technical challenge revolves around the diversity and restricted accessibility of datasets utilized by researchers. The used datasets lack standardization and most often remain unpublished. This limits the reproducibility of results and also can lead to contradictory approaches or findings. Overall, this hampers the progress in the field. The second technical challenge pertains to the often simplified representation (e.g., only location, crime type, and outcome) of the complexity of crime cases within a dataset. Crime investigation does not operate in a vacuum and can go along with several external factors. This includes public and political pressure, as well as the link to geospatial information, weather conditions, and socio-economic factors. Existing crime datasets do not capture or address this complexity, but research shows that those external factors are important for crime solvability.

To overcome the technical problem of the limited data availability, an embodiment of the present invention provides a modular framework which builds a comprehensive crime dataset from multiple data sources. To tackle the technical challenge of adequately representing the complexity, the framework harmonizes and links detailed crime information, geographical information, and points of interest. The framework serves as a foundation for future research in the field, establishing a reproducible and cohesive dataset for future investigations. In addition, it is demonstrated that knowledge graphs (KGs) are a suitable data structure to capture the complexity of crime cases, and also are appropriate when it comes to AI-supported crime solvability. This is underpinned with a detailed literature study on crime solvability factors for different crime types. This includes the coherence of different groups and combinations of crime solvability factors.

The exemplary embodiment demonstrates the following improvements:
Providing a definition of crime solvability, backed by a comprehensive crime solvability factors study.
Providing a framework for generating crime datasets by linking crime cases to various details, including streets, districts, nearby points of interest such as police stations, and other crime cases.
Utilizing knowledge graphs for crime solvability, leading to enhanced solvability computation.

As policing can be diverse, the exemplary embodiment focuses mainly on the situation in the United Kingdom (UK) and United States of America (USA).

When talking about criminal offenses, police terminology shows considerable variation, not least because one must distinguish between legal terminology and the common usage. Criminal offenses, crimes, or incidents are synonymous and can be generally split into two categories: minor and serious (In American terminology, the terms misdemeanor (minor crime) and felony (serious crime) are usually used instead). Minor comprises less serious crimes, without violence, and serious entails criminality that can include (physical) harm, drug dealing, organized crimes and tax fraud. As every crime is different, there are guidelines for conviction (e.g., the Crown Prosecution Service (public agency in the UK) provides guidance). In addition, the harm level of a crime has an influence on the importance of a crime case; hence, the harm level is commonly used to prioritize or weight crimes.

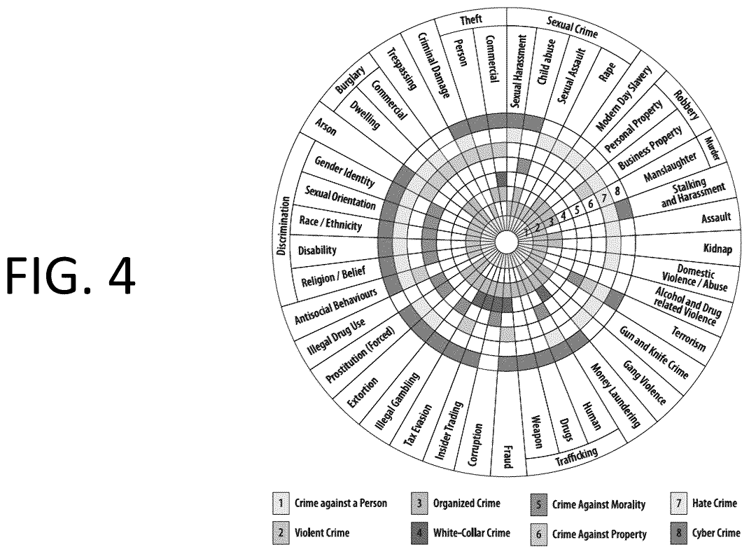

FIG. 4 introduces a general overview of crime types and groups, in particular showing crime type landscape. There are eight major crime categories, and each crime type and potential subtype is associated with at least one of these categories. The term crime types does not refer to a specific list of crimes but is rather a collective term for crimes like murder or burglary, including respective sub-categories. Crimes are also referred to as crime cases or criminal cases handled by the police or court. The investigation of a crime case can be divided into two stages, namely the initial or preliminary investigation followed by the secondary investigation. During the preliminary investigation, the police investigates what has happened to establish the nature of the event or incident, if possible interviews the victim(s), and collects evidence, e.g., statements, forensic material or photos. The secondary investigation takes place after the primary one has established the facts to a sufficiency that it can classify the circumstances and nature of the offense committed.

Existing approaches and research provide no clear definition for crime solvability, but rather share the common understanding that the term crime solvability describes how likely it is to solve a case. In the UK, the term solved is used as a synonym for detected, where detected has a formal definition. A national classification schema defines when a particular crime type can be marked as solved. It is to be noted that this classification schema is not static, but has been constantly evolving over time. The causes of a case being marked as solved can be diverse. In the UK, and in other countries, the causes depend on the crime type. For instance, a residential burglary case can be marked as solved when an arrest was made. A conviction is not necessary. For other crime cases, it is necessary to satisfy a prosecutor that there is sufficient evidence to charge a person with the crime. A case can also be marked as solved if there is no public interest in the crime, or simply when a certain time has elapsed. Thus, while there are various reasons to mark a case as solved, solved is rather used as a collective term to categorize cases. The intention is to get cases out of the policing system to keep it clear and to focus on active cases.

Existing research about crime solvability usually focuses on identifying factors, so-called solvability factors, which allow predicting whether the case is going to be solved. In this context, while the precise definitions may differ slightly, the term crime solvability is commonly employed to describe if and how well a case can be solved. Taking all of this information into account, an embodiment of the present invention defines crime solvability as follows: crime solvability is an assessment to determine and predict investigative success, i.e., whether a particular case is going to be solved. The prediction is an assessment in terms of a solvability score.

The solvability score represents the probability of a case being solved. The probability is derived from the presence or absence of solvability factors which are associated with the crime type of interest. Solvability factors denote evidence or other factors that contribute to the solving of a crime case. The meaning of solving is determined by the crime type of interest.

So far, only few papers have presented decision models based on solvability factors. The earliest decision models showed that it is feasible to point the police in the direction of solvable cases. As a follow-up, these approaches were replicated and enhanced by considering additional solvability factors. However, the authors cautioned that their findings must be considered with caution, due to the limited data availability, and concluded that a comprehensive data basis is important for reliable results. A more recent approach used crime solvability factors to improve the efficiency of Kent Police's (in UK) crime case investigations. Indeed, several works outline that crimes possess characteristics which allow determining the degree of solvability. These works demonstrate the feasibility of crime solvability, but also highlight the technical problem that the limitations of the available datasets hinder more reliable results. Within this context, it is also a technical problem that working with datasets which are limited to factors like crime type, location, and time information leads to a biased outcome. Moreover, it has been shown that crime solvability factors like offender and victim behaviors, credible suspect information, neighborhood information, forensic evidence, weather conditions, socio-economic factors and demographic sentiments are important for crime analysis.

Recently, the landscape of publicly available crime datasets was investigated, resulting in identifying thirty datasets and dividing them into five groups, including a group on criminal activities. From all the surveyed datasets, only three provided data directly on the underlying criminal activity. This highlights that none of the datasets can be linked at the instance level, and that any future work to enable this would be beneficial.

An additional noteworthy crime dataset is from the Los Angeles Police Department (USA), which actively maintains an additional criminal dataset on criminal activities. To date, the dataset is regularly updated and provides data for the last ten years. Notably, the dataset includes information about the location, victim, involved weapons, crime type, a description of the crime, and the outcome. While this dataset belongs to the most detailed ones, it still misses important crime solvability factors.

Overall, the prior approaches and research show on the one hand that crime solvability can be determined with crime solvability factors and that solvability can increase the investigative success by pointing the police in the direction of solvable cases. On the other hand, the current dataset landscape consists of inaccessible, limited, and non-uniform datasets, restricting the research in understanding criminal incidents and presenting technical obstacles to their solvability. The exemplary embodiment discussed in the following overcomes these technical obstacles by focusing on enriching and linking crime datasets.

Crime solvability factors serve as a foundation to determine the likelihood of a crime case being solved. In the following, existing research is analyzed to understand the typical factors of interest. The goal is not to present a complete overview of all existing crime solvability factors, but rather to understand the diversity and requirements for predicting investigate success. An extensive literature review did result in more than two hundred solvability factors. These factors have been analyzed by the respective works to understand their impact on crime solvability for various crime types. This work is put into context to investigate the different factor types, and to discover open issues.

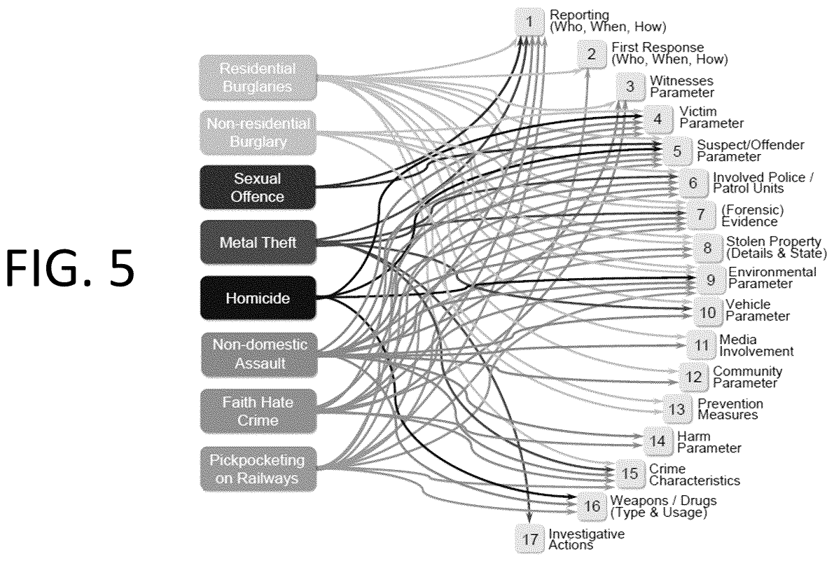

FIG. 5 illustrates the identified crime solvability factor groups. These groups were derived from examining the over two hundred distinct factors identified in the existing literature. The groups are linked to selected crime types, illustrating which combinations of crime types and solvability factors have been studied. FIG. 5 indicates that not all groups are necessarily of interest for all crime types. However, it needs to be considered that not all crime types were studied equally. For example, almost no work considered factors of the group investigative actions. Those include crime type specific characteristics, such as checking the scrap metal dealer for metal theft cases. This is similar for residential burglary cases where the types of stolen goods (e.g., camcorder or cameras) have been taken into account, but examining potential trading or selling platforms (investigative actions) was not considered as a solvability factor. It is likely that these limitations and shortcomings can be attributed to the used datasets in the respective studies. In contrast, there are also crime solvability factor groups (e.g., environmental parameters) which are linked to most crime types. Hence, the importance of those seems evident; however, existing literature do not provide insights whether the level of importance of the same factor varies across different crime types.

Another observation is that most works disregard the investigation process of a crime case. Thus, they ignore the fact that solvability factors occur at different stages of the investigation process. For example, the availability of cameras can be already secured before the crime actually happened (prevention measure), where the response time (i.e., first police officer at crime scene) belongs to the preliminary investigation phase. Forensic evidence related factors are collected in the subsequent phase. While this may appear self-evident, two things to note are: police decision-making has a high influence on the quality of the factors (e.g., first person at the crime scene) and determining a crime solvability score during the preliminary investigation would need to happen without reliable factors of the secondary investigation like forensic evidence.

In addition to the aforementioned points, analyzing crime solvability factors often goes along with bias and ethics aspects. Correlation does not imply causation and, as such, identifying crime solvability factors needs to be done with caution. For instance, one work lists “area with high male unemployment” as a crime solvability factor for solving residential burglaries. It seems questionable to narrow down a crime solvability factor to a specific group of people.

Last, the outcome of a crime case might be influenced by external factors, which are not necessarily reflected by the crime case records. Specifically, public interest can have a significant influence on solving a case. For example, it may cause more resources than usual to be devoted to a case. Further, if there is a high interest, the public might provide more information or be more attentive. In contrast, public interest can also bias the public media and vice versa, which can have a positive or negative influence on the investigation. In the following, these findings are used to ensure a reasonable selection of factors for the data schema in the crime dataset construction framework according to an embodiment of the present invention. Further, the findings are also taken into account when devising the experimental setup for AI-supported crime solvability according to an embodiment of the present invention.

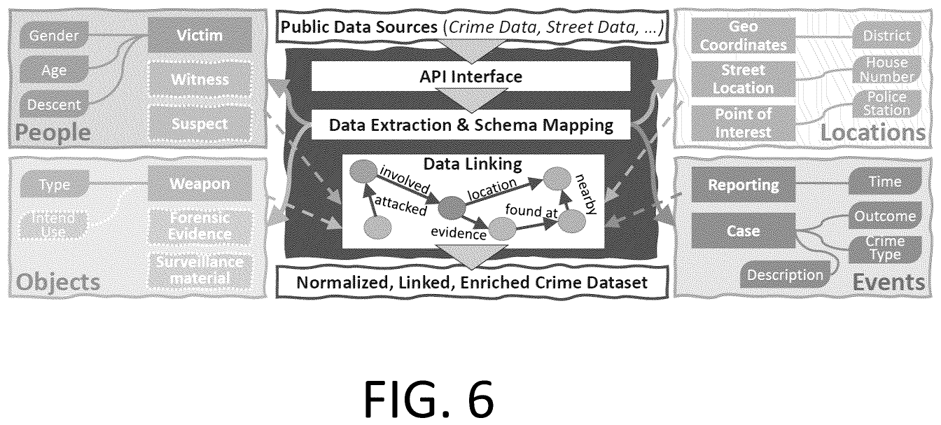

FIG. 6 shows a crime dataset construction framework according to an embodiment of the present invention, in particular a comprehensive and modular framework, incorporating application processing interface (API) integrations, data extraction methodologies, and data linking techniques. It constructs a linked crime dataset incorporating data from each dimension (i.e., people, locations, objects, and events) including the outcome of the case (i.e., solved or not solved). The elements in dashed boxes (witness, suspect, intended use, forensic evidence, surveillance material) are typically undisclosed, but are important factors. Generative AI holds the potential to fill this gap.

The availability of high-quality datasets for this sensitive topic is crucial for reliable research. Given the existing regulations and laws, it is unlikely that governments or police forces will provide the necessary datasets. Therefore, it is a technical challenge to find approaches for creating comprehensive and dependable crime datasets, which in turn facilitates consistent and practical research.

To address this challenge, an embodiment of the present invention implements a software framework which loads crime-related information from multiple data sources to build a comprehensive crime dataset. In particular, the framework includes API integrations, data extraction methods, and also data linking techniques. The data undergo a transformation process to ensure consistency and a common schema. An advantage of the software framework is that it can be easily distributed without data protection concerns, as any actual data is not included. The framework operates through accessing open endpoints, i.e., the user needs to make a decision when using the framework.

The to-be-constructed crime dataset relies on the concept of the POLE data structure. POLE stands for People, Objects, Locations, and Events, and is a data model used in law enforcement agencies to organize and manage data related to criminal investigations. Each component represents a crucial aspect and allows to systematically analyze and investigate criminal activities. To be specific, people refers to individuals involved in criminal incidents, including suspects, victims, witnesses, and investigators. Objects comprise physical items such as weapons or stolen goods. Locations describe the geographical context of criminal incidents (e.g., addresses, coordinates, or landmarks) where events encompass the chronological details (e.g., modus operandi). This concept was taken into consideration while designing and integrating the data schemas into the framework according to an embodiment of the present invention.

FIG. 6 shows the architecture of the framework according to an embodiment of the present invention. The starting point is the Los Angeles Police Department crime dataset as it is the most comprehensive dataset which is publicly available. However, the framework is not restricted to this dataset, as it provides predefined interfaces to integrate additional crime dataset sources. Besides the crime information, such as involved entities, reports, or evidence, the framework also integrates geographical information (e.g., city districts and street information) and point of interests (e.g., police stations, school, and restaurants). Through extensive computations, the data points are linked in respect of their distance and location. Hence, each crime record is linked to a street through reverse geocoding. A nearby search extends the street record with respective points of interest. Relying on the latitude and longitude information allows determining which points of interest are in a certain range of a crime record (e.g., within 50 meters). Moreover, spatial analysis enables to assign each crime, street, and point of interest (POI) record to the respective district, and also to determine which districts are neighboring. The framework supports multi-threading and was executed on a machine with 8 cores/16 threads.

To ensure data quality, all data records are converted to a predefined POLE-based schema where the schema includes data types, data ranges, and (if required) definitions. For example, street and point of interest records were loaded from OpenStreetMap (<<https://wiki.openstreetmap.org/wiki/API>>). As this data source has many contributors, the data quality varies, e.g., in terms of standardization. Extensive data mining and engineering techniques are utilized to clean, filter, and merge attribute fields in the data records. This process ensures data accuracy, removes irrelevant information, and consolidates related attributes, resulting in a refined and organized dataset for analysis. In the end, the framework stores the converted and linked data into a key value based database. In particular, MongoDB was used in the exemplary embodiment as it supports nested key value structures and also allows to easily query or filter the comprehensive dataset. This is especially of interest if one wants to convert the data structure or just needs to work with a subset.

The framework created a standardized Los Angeles related crime dataset consisting of almost three million crimes records (with more than one hundred different crime types), ~forty-two thousand unique streets, ~twenty thousand point of interests, all linked to more than one hundred districts. Moreover, the crime records are timestamped, allowing for the opportunity to conduct time-dependent analyses. As the framework is modular, it can easily be extended with additional information such as the weather, compliance reports, or demographics.

The framework is not limited to Los Angeles, but rather uses this dataset to showcase its capabilities. The framework is publicly available (<<https://github.com/solvabilitypaper/crime-dataset-pipeline>>) and can be accessed by anyone. After taking a look on generative AI, empirical evidence is provided that this dataset is suitable for crime analysis. Moreover, the appropriateness of knowledge graphs as a data structure for crime analysis is demonstrated, as it was discovered to enable effective data integration, knowledge discovery, and make it easier to analyze interconnected data.

Generative AI is currently a hot topic in machine learning as the latest technology of LLMs such as ChatGPT (by OpenAI) and Bard (by Google) demonstrate a high accuracy in many generative Natural Language Processing (NLP) tasks. LLMs have the potential to generate synthetic data; hence, the technology might be used for solutions to overcome the identified issue of limited crime solvability factors in available datasets. Existing literature shows that there are two common strategies to use LLMs for generating synthetic data. The first one utilizes the LLMs translation and phrasing capability to generate multilingual data. In particular, it creates alternative phrase variants and therefore scales up an existing dataset. The second approach creates new synthetic data using customized prompts (i.e., queries) to instruct the LLM.

As an initial experiment, a prompt was constructed consisting of a predefined JavaScript Notation Object (JSON) data structure partly filled with facts of a real burglary crime case. The instruction text stated that the empty fields need to be filled. We used this prompt with ChatGPT and Bard, and both models successfully completed the JSON data structure with reasonable details.

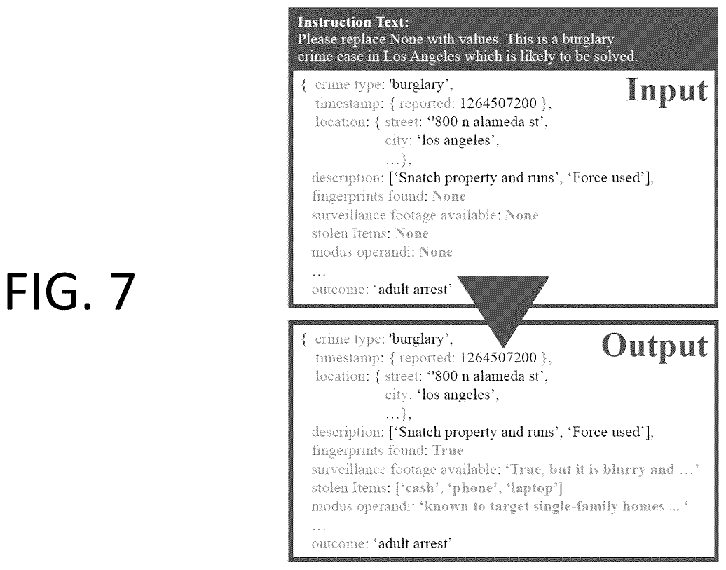

FIG. 7 shows a synthetic crime dataset example with generating missing solvability factors with an LLM (Bard). The input consists of a predefined JSON schema, partly filled with facts of a real burglary crime case. The LLM fills missing fields with reasonable details. FIG. 7 shows an excerpt of the prompt and response from Google's Bard.

This initial testing result indicated promising results to augment the framework according to an embodiment of the present invention with an additional module to complement the real data with synthetic data. The LLM in the example did fill-in all fields correctly, was able to provide different data types (e.g., string, boolean, and list), and provided varying results for different requests. Notably, the filled-in values were consistent with the provided facts. However, it should be noted that there are additional technical challenges to this data generation strategy, which are also addressed by embodiments of the present invention. These include the difficulty of constructing proper prompts, checking for correctness and addressing the potential bias that may exist in the training data of the LLM.

In the following, advantages of an exemplary embodiment of the framework according to an embodiment of the present invention are discussed for an application of the framework to graph-based crime solvability with a specific focus on burglary crime cases.

A primary objective of the following description is to exemplify that the output of the framework enables the prediction of crime solvability, and also that crime solvability holds the potential to enhance resource optimization and operational efficiency. To accomplish this, a knowledge graph is built from the framework generated dataset and a node classification technique is utilized to determine the solvability score for burglary crime cases.

Use Case: Solvability for Burglaries. Residential burglary cases were selected as an example because the crime solvability factor study shows that several factors related to burglary are well-represented in the dataset. This includes crime characteristics (Objects and Events), environmental parameters like nearby police stations (Locations), and victim parameters (People) (see FIG. 5). Hence, there is a greater degree of confidence that the framework provides for this crime type sufficient data to compute a solvability score with a higher degree of reliability. Still, the approach according to embodiments of the present invention can be used also for arbitrary crime types in other use cases. The example focuses on burglary crime cases located in Downtown Los Angeles. Within the dataset, there are in total 4,847 real burglary cases, out of which 476 have been successfully solved. The dataset is imbalanced because the clearance rate tends to be low for burglary offenses. While it is also generally advantageous to be able to predict solvable and unsolvable cases, a particular focus is on predicting the unsolved cases with a high precision. Knowing how likely a case is to remain unsolved can provide valuable insights for optimizing the allocation of limited policing resources. The experiments focused on the situation after the preliminary investigation is completed.

Burglary Knowledge Graph: Crimes have several dimensions (People, Objects, Locations, and Events) and as such are complex and can differ significantly. Turning such information into a conventional data representation (e.g., tabular data), can lead to the loss of relationships and connections between the data points. This applies not only to POLE entities involved in a case, but also to the interconnections and patterns that exist across multiple cases. According to an embodiment of the present invention, it is proposed that Knowledge Graphs (KGs) are a suitable solution, as they are flexible and able to model relations.

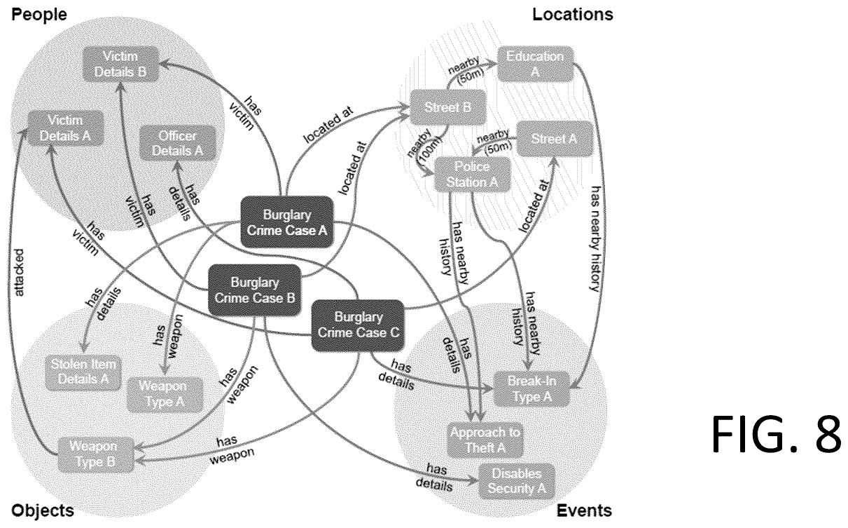

FIG. 8 illustrates the data schema according to an embodiment of the present invention and also shows an excerpt of the burglary dataset of the exemplary use case. Each burglary case is modeled as a node, where these nodes are linked to nodes representing crime descriptions and locations. The crime descriptions are represented by 170 distinct categories, each representing specific solvability features (e.g. victim knocked to ground or home under construction). Further, the graph consists of 8 different edge types encoding the relation of the nodes, including the geographical distance.

Experimental Setup: The crime solvability prediction problem was framed as a binary classification task, where each node of a burglary case should be classified as either solvable or unsolvable. For that purpose, the dataset was split into training (60%), validation (20%), and testing (20%) sets. The data was temporally partitioned to maintain the temporal order; hence, the validation set only contained cases that occur chronologically after the cases in the training set, and all cases in the testing set occur after the validation set. As the dataset is imbalanced, undersampling of the majority class (i.e., unsolved) in the training set was performed. The performance of the model was evaluated with standard classification metrics, in particular, F1, Balanced Accuracy, and AUROC.

TABLE 1
Classification result for predicting the outcome (solved
(S) or unsolved (U)) of burglary crime cases. To compute
the harmonic mean (F1) and the balanced accuracy (BA),
the Solvability Score was discretized (T = 0.5)

| Method | F₁(S) | F₁(U) | BA | AUROC |
|---|---|---|---|---|
| Graph | 0.63 | 0.97 | 0.78 | 0.87 |
| Tabular | 0.17 | 0.96 | 0.55 | 0.83 |

TABLE 2
Classification result for unsolved burglary crime
cases using the graph-based model. The Solvability
Score was discretized for selected thresholds (T).

| Metric | T = 0.70 | T = 0.80 | T = 0.90 | T = 0.95 |
|---|---|---|---|---|
| Precision | 0.97 | 0.97 | 0.98 | 0.99 |
| Recall | 0.97 | 0.92 | 0.76 | 0.38 |

An established node embedding algorithm was applied to learn an n-dimensional vector representations for each node in the knowledge graph. The representation was learned through unsupervised learning, specifically by applying a negative sampling strategy to compute the loss value. The learned vectors served as input for the classification model, specifically a Logistic Regression (LR) model.

To validate the impact of the knowledge graph data structure on the prediction performance, a comparative analysis was conducted between the graph-based model and a tabular-based model. To create the tabular dataset, the knowledge graph was transformed into a tabular format, where each row represents a burglary crime case. To ensure comparability, an LR model was also used for classifying the tabular data.

Results: The experimental results showed three important insights: First, the output of the software framework according to the exemplary embodiment effectively facilitated crime solvability prediction (see Table 1). Second, the experimental results indicate that the inclusion of the graph data structure significantly improves the prediction accuracy (see Table 1, cf. Graph and Tabular). Third, high precision was achieved in classifying unsolved cases while maintaining an acceptable recall rate (see Table 2). While a significant improvement was already observed for predicting solvable cases when relying on the graph structured data, there is still potential for further improvement. Considering the solvability factors study, incorporating additional information to the dataset framework has the potential to enhance the prediction performance even further. However, the example also shows that the availability of factors is limited. Utilizing generative AI can serve as one approach to fill this gap.

Explainability, Trust and Ethics: From a legal and ethical perspective, a police officer should understand why and how the AI model came up with a certain outcome. This allows the officer to assess the prediction outcome, to justify decisions towards others, and to build trust between human and AI. The AI algorithm should come with an explanation, i.e. it should be transparent, in a sense that the police officer understands why it came up with a particular prediction. Further, such an explanation or reasoning of the AI system can help the police officers to analyze crime cases from a different perspective. The need for explainable predictions goes along with the need for bias-free predictions. Crime records reflect the policies and practices of a force, district, and country; hence, the data is biased naturally. For instance, the crime records might reflect that people living in a poor district are likely to commit an offense. However, it is questionable to judge people based on their living situation. The same assumptions are valid for factors like ethnic group, profession, gender, culture, and religion. Several of these parameters were actually considered as crime solvability factors by recent studies. Nonetheless, even in this challenging real world scenario, an AI model can be used as an automated tool which can be used to gather knowledge to support decision making.

This exemplary embodiment and exemplary use case was intended to demonstrate the advantages of a reproducible linked dataset creation framework according to an embodiment of the present advantage, and to demonstrate the solutions to the technical challenges associated with the limited availability and quality of datasets, while also addressing the commonly oversimplified data representation of crime cases.

In the following, details on experimental settings and on the Solvability Factors that have been analyzed on Solvability prediction are provided.

Details on Experimental Settings: The code for the dataset framework as well as the node classification experiments are available at <<https://github.com/solvabilitypaper/crime-dataset-pipeline>> and are hereby incorporated by reference herein.

Dataset Framework: The Dataset framework supports multi-threading and was executed on a machine with 8 cores/16 threads (i7-11700K@3.60 GHz). It required approximately two weeks to finish the computations.

Solvability Prediction: All experiments were run on servers. Node embeddings were computed with DistMult. Each node in the KG is represented by one embedding vector. Then, a tabular classification algorithm was run to learn the class (solved/not solved) for each burglary case based on its embedding vector. Random Forest were used for the classification. For the tabular classification baseline, one-hot encoding was used to model the presence or absence of each triple in the KG.

Details on Crime Solvability Factors: Tables 3 and 4 show more than 200 Crime Solvability Factors for Crimes Against a Person (Sexual Offense, Murder, Non-domestic Assaults, Faith Hate Crime), Non-Violent Crimes (Pickpocketing on Railways, Metal Theft), and Crimes Against Property ((Non-)Residential Burglary). Bold entries mark Crime Solvability Factors which occur for at least two crime types.

Table 3 shows the Crime Solvability Factors studied in related work, Part 1/2. The bold entries indicate that the respective factor occurs for at least two crime types, where the numbers represent the corresponding Crime Solvability Factor group (see FIG. 5).

TABLE 3

| Crime Type | Crime Solvability Factor | Reference |
|---|---|---|
| Residential | offence reporting party¹, method of reporting¹, | (Donnellan |
| Burglary | documentation/report type¹, report available¹, discovered by the | and Ariel |
| (including | police^{1, 6}, response time (of first patrol)², offender seen^{3, 5}, | 2019; Paine |
| repeats and in- | offender modus operandi¹⁵, number of neighbours with view of | and Ariel |
| progress) | target entry point^{3, 12}, suspect named⁵, suspect | 2019; Coupe |
| | described/information⁵, number of patrol units⁶, | and |
| | documentation/footprints/fingerprints/DNA/other forensic | Mueller- |
| | evidence at primary scene⁷, CCTV⁷, anything left at scene⁷, | Johnson |
| | property stolen⁸, value of property stolen⁸, stolen property | 2019a; Coupe |
| | recovered⁸, types of goods stolen (antiques, camcorder, camera, | 2019b, a) |
| | cash, chequebook, credit card, clothing, household electrical, | |
| | jewellery, power tools)⁸, targets where electrical goods⁸, disposal | |
| | code⁹, day of week⁹, time of day⁹, committed during | |
| | darkness/daylight⁹, premises were occupied⁹, mean distance of | |
| | houses with view of approaches to target⁹, 20 or more dwellings | |
| | with view of approaches to target⁹, single-adult household⁹, | |
| | house situated in middle of street versus at corner or next to | |
| | alley⁹, height of rear cover (vegetation, walls, fencing)⁹, dwelling | |
| | type: apartment, terraced dwelling, or whether built prior to | |
| | 1945⁹, exposure: cover index/rear cover index/height of front | |
| | cover⁹, vehicle in- formation¹⁰, vehicle stolen in crime¹⁰, media | |
| | appeal completed¹¹, area with high male unemployment¹², | |
| | burglar alarm fitted prior to burglary¹³, security lights fitted prior | |
| | to burglary¹³, front door deadlocks¹³, offence duration¹⁵, | |
| | attempted burglary or not¹⁵, burglary in progress¹⁵, offender | |
| | disturbed¹⁵, premise was subject to previous burglary¹⁵, more | |
| | than one room in target visited/number of rooms visited¹⁵, | |
| | burglary stage (entering or inside)¹⁵ | |
| Pickpocketing | witness report of offence¹, victim's perceived range of offence | (Sharp and |
| on Railways | time¹, response time², victim vulnerable or intimidated⁴, | Coupe 2019) |
| | suspect/victim gender^{4, 5}, suspect/victim age^{4, 5}, ethnicity^{4, 5}, | |
| | number of suspects⁵, suspect described/information⁵, British | |
| | Transport Police subdivision⁶, CCTV⁷, value of property | |
| | stolen >£500⁸, phone or electronic device stolen⁸, season⁹, time of | |
| | day⁹, location type (e.g., train, platform, concourse, inner station, | |
| | shops)⁹, journey type: static or moving¹⁵, alcohol or drugs | |
| | involved¹⁶ | |
| Sexual | method of reporting¹, offender seen⁵ | (Jones, |
| Offence | | Coupe, |
| | | and |
| | | Mueller- |
| | | Johnson |
| | | 2019) |
| Non-domestic | reported in front office¹, reported to help desk/contact | (Olphin and |
| Assaults | center/patrol¹, number of statements (zero, one, two or more)¹, | Mueller- |
| | reported within 5 minutes¹, witness outstanding³, victim- | Johnson |
| | offender relationship^{4, 5}, suspect described/information⁵, at | 2019) |
| | least one suspect information form⁵, forensic scene investigator | |
| | dispatched⁶, forensic scene investigator dispatched⁶, forensic | |
| | evidence at primary scene⁷, something recovered by forensic | |
| | scene investigator⁷, CCTV⁷, at least one forensics form⁷, at least | |
| | one drawing or photograph⁷, at least one miscellaneous | |
| | document⁷, property flagged⁸, at least one property form⁸, | |
| | private indoor or outdoor⁹, public indoor or outdoor⁹, offence | |
| | on licensed premises⁹, offence in dwelling⁹, committed during | |
| | darkness/daylight⁹, vehicle registration mark details¹⁰, vehicle | |
| | used as weapon^{10, 16}, media interest¹¹, high-profile case^{11, 15}, | |
| | community tension¹², actual bodily harm¹⁴, wounding¹⁴, | |
| | grievous bodily harm with or without intent¹⁴, attempted | |
| | murder¹⁴, visible injury¹⁴, offence duration¹⁵, mandatory for | |
| | investigation¹⁵, critical incident¹⁵, series¹⁵, hate offence¹⁵, | |
| | sharply pointed object (e.g., knife, blade)¹⁶, lethal firearm¹⁶, | |
| | opportunistic weapon¹⁶, non-lethal or imitation firearm¹⁶, blunt | |
| | instrument¹⁶, other weapon¹⁶, weapon used injury/damage¹⁶, | |
| | weapon used threat or other¹⁶, weapon carried or believed - not | |
| | used¹⁶, weapon use | |
| | not recorded¹⁶, alcohol or drugs involved (AI/DI marker)¹⁶ | |

TABLE 4
Table 4: Crime Solvability Factors studied in related work, Part 2/2. The bold
entries indicate that the respective factor occurs for at least two crime types,
where the numbers represent the corresponding Crime Solvability Factor group.

| Crime Type | Crime Solvability Factor | Reference |
|---|---|---|
| Faith Hate | method of reporting¹, delay in reporting¹, when reported¹, | (Rose, |
| Crime | reported on/off peak (9am-9pm)¹, police witnessed offence³, | Coupe, and |
| | number of witnesses³, victim gender⁴, victim age⁴, victim | Ariel 2019) |
| | occupation⁴, corporate/personal victim⁴, repeat victim^{4, 15}, | |
| | ethnicity^{4, 5}, rank of investigator⁶, team dealing⁶, CCTV⁷, | |
| | forensic deployment⁷, venue (public open space, in/or on | |
| | transport, in residential address, in public/private | |
| | venue)⁹, investigating borough⁹, person injured¹⁴, type of faith | |
| | hate¹⁵, crime type | |
| | (assault/slash not assault, criminal damage, public order)¹⁵ | |
| Non- | types of premises targeted⁴, organization employee numbers⁴, | (Coupe and |
| residential | CCTV⁷, types of goods stolen⁸, number of burglars CCTV | Mueller- |
| Burglary | filmed in prior six months⁹, number of neighbours with | Johnson |
| | downstairs/upstairs target view⁹, non-residential premises with | 2019b) |
| | rear of target view⁹, five or more roads or paths in vicinity of | |
| | target⁹, no side road⁹, no open ground at side of target⁹, no woods | |
| | at side of target⁹, road at rear of premises⁹, numbers of | |
| | neighbours with an opposite view/a side view of rear⁹, distance | |
| | from the nearest road junction (yards)⁹, brighter street lighting⁹, | |
| | security index⁹, distance from closest neighbour⁹, mean distance | |
| | from visible neighbours (mutually visible)⁹, distance from | |
| | facing neighbouring properties⁹, number of roads or paths in | |
| | vicinity of target⁹, road at side of target⁹, open ground at side of | |
| | target⁹, distance between street lights⁹, distance of target from the | |
| | nearest street light⁹, height of front cover⁹, number (of | |
| | visible/hidden) CCTV cameras¹³, security patrols at premises¹³, | |
| | alarms fitted¹³, delayed audible alarms fitted¹³, number of | |
| | alarms fitted¹³, rein- forced doors fitted at target¹³, extra locks | |
| | fitted at target¹³, bars/grills and shutters | |
| | fitted at target¹³, toughened glass fitted at target¹³, security | |
| | lighting fitted at target¹³ | |
| Metal Theft | witness report of offence¹, patrol discovered^{1, 6}, forensic | (Robb, |
| | evidence at primary scene⁷, CCTV⁷, vehicle | Coupe, |
| | information¹⁰, offender disturbed¹⁵, alarm activation¹⁵, | and Ariel |
| | scrap metal dealer checked¹⁷ | 2019) |
| Murder | victim-offender relationship^{4, 5}, number of suspects⁵, day of | (Riggs, |
| | week⁹, time of day⁹, | Coupe, |
| | weather⁹, crime weapon type¹⁶ | and O'Connor |
| | | 2019) |

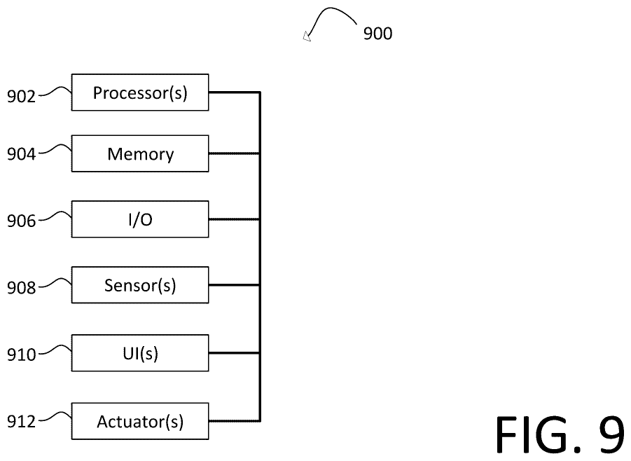

Referring to FIG. 9, a processing system 900 can include one or more processors 902, memory 904, one or more input/output devices 906, one or more sensors 908, one or more user interfaces 910, and one or more actuators 912. Processing system 900 can be representative of each computing system disclosed herein.

Processors 902 can include one or more distinct processors, each having one or more cores. Each of the distinct processors can have the same or different structure. Processors 902 can include one or more central processing units (CPUs), one or more graphics processing units (GPUs), circuitry (e.g., application specific integrated circuits (ASICs)), digital signal processors (DSPs), and the like. Processors 902 can be mounted to a common substrate or to multiple different substrates.

Processors 902 are configured to perform a certain function, method, or operation (e.g., are configured to provide for performance of a function, method, or operation) at least when one of the one or more of the distinct processors is capable of performing operations embodying the function, method, or operation. Processors 902 can perform operations embodying the function, method, or operation by, for example, executing code (e.g., interpreting scripts) stored on memory 904 and/or trafficking data through one or more ASICs. Processors 902, and thus processing system 900, can be configured to perform, automatically, any and all functions, methods, and operations disclosed herein. Therefore, processing system 900 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 900 can be configured to perform task “X”. Processing system 900 is configured to perform a function, method, or operation at least when processors 902 are configured to do the same.

Memory 904 can include volatile memory, non-volatile memory, and any other medium capable of storing data. Each of the volatile memory, non-volatile memory, and any other type of memory can include multiple different memory devices, located at multiple distinct locations and each having a different structure. Memory 904 can include remotely hosted (e.g., cloud) storage.

Examples of memory 904 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 904.

Input-output devices 906 can include any component for trafficking data such as ports, antennas (i.e., transceivers), printed conductive paths, and the like. Input-output devices 906 can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices 906 can include wired and/or wireless communication pathways.

Sensors 908 can capture physical measurements of environment and report the same to processors 902. User interface 910 can include displays, physical buttons, speakers, microphones, keyboards, and the like. Actuators 912 can enable processors 902 to control mechanical forces.

Processing system 900 can be distributed. For example, some components of processing system 900 can reside in a remote hosted network service (e.g., a cloud computing environment) while other components of processing system 900 can reside in a local computing system. Processing system 900 can have a modular design where certain modules include a plurality of the features/functions shown in FIG. 9. For example, I/O modules can include volatile memory and one or more processors. As another example, individual processor modules can include read-only-memory and/or local caches.

### REFERENCES

Veselovsky, Veniamin, et al., “Generating Faithful Synthetic Data with Large Language Models: A Case Study in Computational Social Science,” arXiv preprint arXiv:2305.15041 (2023).
Beuthner, Christoph, et al., “Data linking—linking survey data with geospatial, social media, and sensor data.” GESIS Survey Guidelines (2021).
Ashby, M. 2018. Comparing methods for measuring crime harm/severity. Policing: A Journal of Policy and Practice, 12(4): 439-454.
Bappee, F. K.; Soares, A.; Petry, L. M.; and Matwin, S. 2021. Examining the impact of cross-domain learning on crime prediction. Journal of big data, 8: 1-27.
Bard, Google AI. 2023. An Example for generating missing Solvability Factors with a LLM. https://bard.google.com/. Accessed: 2023 Jul. 28.
College of Policing (United Kingdom). 2021. Investigation process. https://www.college.police.uk/app/investigation/investigation-process. Accessed: 2023 Aug. 14.
Coupe, R. T. 2019. The Organisation and Deployment of Patrol Resources: Cost-Effective On-Scene Arrest at Burglaries. In Crime Solvability Factors: Police Resources and Crime Detection, 391-410. Cham: Springer International Publishing.
Coupe, R. T. 2019. Investigative Activities, Resources and Burglary Detection. In Crime Solvability Factors: Police Resources and Crime Detection, 367-389. Cham: Springer International Publishing.
Coupe, R. T.; Ariel, B.; and Mueller-Johnson, K. 2019. Introduction. In Crime Solvability Factors: Police Resources and Crime Detection, 1-14. Cham: Springer International Publishing.
Coupe, R. T.; and Mueller-Johnson, K. 2019. Boosting Offence Solvability and Detections: Solving Residential Burglaries by Predicting Single and Multiple Repeats. In Crime Solvability Factors: Police Resources and Crime Detection, 287-304. Cham: Springer International Publishing.
Coupe, R. T.; and Mueller-Johnson, K. 2019b. Improving Offence Solvability and Detection Rates at Non-residential Burglary: Predicting Single and Multiple Repeat Incidence. In Crime Solvability Factors: Police Resources and Crime Detection, 305-329. Cham: Springer International Publishing.
Depeau, J. 2018. Graph Technology is in the POLE Position to Help Law Enforcement. https://neo4j.com/blog/graph-technology-pole-position-law-enforcement/. Accessed: 2023 Aug. 14.
Donnellan, P. G.; and Ariel, B. 2019. Assessing Solvability Factors in Greater Manchester, England: The Case of Residential Burglaries. In Crime Solvability Factors: Police Resources and Crime Detection, 35-51. Cham: Springer International Publishing.
Eck, J. E. 1979. Managing case assignments: The burglary investigation decision model replication. Washington, D.C.: Police Executive Research Forum, U.S. Department of Justice, National Institute of Justice.
Eck, J. E. 1983. Solving crimes: The investigation of burglary and robbery. Washington, D.C.: Police Executive Research Forum, U.S. Department of Justice, National Institute of Justice.
Greenberg, B.; Elliot, C.; Kraft, L.; and Procter, H. S. 1977. Felony investigation decision model: An analysis of investigative elements of information. Washington, D.C.: U.S. Department of Justice, Law Enforcement Assistance Administration, National Institute of Law Enforcement and Criminal Justice.
Home Office (United Kingdom). 2013. Home Office Crime Recording Rules for frontline officers & staff. https://assets.publishing.service.gov.uk/government/uploads/system/uploads/attachment data/file/1173694/crime-recordingrules-for-frontline-officers-and-staff-july2023.pdf. Published: 2013 Jul. 4. Last updated: 2023 Jul. 26. Accessed: 2023 Aug. 14.
Hu, K.; Li, L.; Tao, X.; Velásquez, J. D.; and Delaney, P. 2023. Information fusion in crime event analysis: A decade survey on data, features and models. Information Fusion, 100: 101904.
Ji, S.; Pan, S.; Cambria, E.; Marttinen, P.; and Yu, P. S. 2022. A Survey on Knowledge Graphs: Representation, Acquisition, and Applications. IEEE Transactions on Neural Networks and Learning Systems, 33(2): 494-514.
Jones, A.; Coupe, R. T.; and Mueller-Johnson, K. 2019. Reporting, Detection and Solvability of Sex Offences on Railways. In Crime Solvability Factors: Police Resources and Crime Detection, 225-256. Cham: Springer International Publishing.
Josifoski, M.; Sakota, M.; Peyrard, M.; and West, R. 2023. Exploiting Asymmetry for Synthetic Training Data Generation: SynthIE and the Case of Information Extraction. arXiv:2303.04132.
Kang, H.-W.; and Kang, H.-B. 2017. Prediction of crime occurrence from multi-modal data using deep learning. PLOS ONE, 12(4): 1-19.
Killmier, B.; Mueller-Johnson, K.; and Timothy Coupe, R. 2019. Offender-Offence Profiling: Improving Burglary Solvability and Detection. In Crime Solvability Factors: Police Resources and Crime Detection, 257-285. Cham: Springer International Publishing.
Kotnis, B.; Gashteovski, K.; Gastinger, J.; Serra, G.; Alesiani, F.; Sztyler, T.; Shaker, A.; Gong, N.; Lawrence, C.; and Xu, Z. 2022. Human-Centric Research for NLP: Towards a Definition and Guiding Questions. In Proceedings of the Second Workshop on Bridging Human-Computer Interaction and Natural Language Processing. Association for Computational Linguistics.
LAPD. 2023. Los Angeles Police Department, Public Safety: Crime Data from 2020 to Present. https://data.lacity.org/Public-Safety/Crime-Data-from-2020-to-Present/2nrs-mtv8. Accessed: 2023 Jul. 27.
McFadzien, K.; Pughsley, A.; Featherstone, A. M.; and Phillips, J. M. 2020. The Evidence-Based Investigative Tool (EBIT): A Legitimacy-Conscious Statistical Triage Process for High-Volume Crimes. Cambridge Journal of Evidence-Based Policing, 4(3): 218-232.
McFadzien, K.; and Sherman, L. W. 2021. “Hold them or fold them:” Evidence-based decisions to discontinue investigations of non-domestic minor violence. Policing: An International Journal, 643-654.
Mugari, I.; and Obioha, E. E. 2021. Predictive policing and crime control in the United States of America and Europe: trends in a decade of research and the future of predictive policing. Social Sciences, 10(6): 234.
Olphin, T.; and Coupe, R. T. 2019. Existing Research on Solvability. In Crime Solvability Factors: Police Resources and Crime Detection, 15-34. Cham: Springer International Publishing.
Olphin, T.; and Mueller-Johnson, K. 2019. Targeting Factors that Predict Clearance of Non-domestic Assaults. In Crime Solvability Factors: Police Resources and Crime Detection, 149-174. Cham: Springer International Publishing.
OpenAI. 2023. GPT-4 Technical Report. arXiv:2303.08774.
Paine, C.; and Ariel, B. 2019. Population-Level Analysis of Residential Burglaries. In Crime Solvability Factors: Police Resources and Crime Detection, 53-74. Cham: Springer International Publishing.
Riggs, R.; Coupe, R. T.; and O'Connor, D. 2019. Homicide Resources, Solvability and Detection. In Crime Solvability Factors: Police Resources and Crime Detection, 331-365. Cham: Springer International Publishing.
Robb, P.; Coupe, R. T.; and Ariel, B. 2019. Metal Theft Solvability and Detection. In Crime Solvability Factors: Police Resources and Crime Detection, 107-126. Cham: Springer International Publishing.
Rose, S.; Coupe, R. T.; and Ariel, B. 2019. Solvability Factors and Investigative Strategy for Faith Hate Crime: Anti-Semitic and Islamophobic Assault, Criminal Damage and Public Order Offences in London. In Crime Solvability Factors: Police Resources and Crime Detection, 175-224. Cham: Springer International Publishing.
Rosenbaum, A.; Soltan, S.; Hamza, W.; Damonte, M.; Groves, I.; and Saffari, A. 2022a. CLASP: Few-Shot Cross-Lingual Data Augmentation for Semantic Parsing. In Proceedings of the 2nd Conference of the Asia-Pacific Chapter of the Association for Computational Linguistics and the 12th International Joint Conference on Natural Language Processing (Volume 2: Short Papers), 444-462. Association for Computational Linguistics.
Rosenbaum, A.; Soltan, S.; Hamza, W.; Versley, Y.; and Boese, M. 2022b. LINGUIST: Language Model Instruction Tuning to Generate Annotated Utterances for Intent Classification and Slot Tagging. In Proceedings of the 29th International Conference on Computational Linguistics, 218-241. International Committee on Computational Linguistics.
Sharp, S.; and Coupe, R. T. 2019. Pickpocketing on Railways. In Crime Solvability Factors: Police Resources and Crime Detection, 89-106. Cham: Springer International Publishing.
Sundar Pichai. 2023. An important next step on our AI journey. https://blog.google/technology/ai/bard-google-aisearch-updates/. Accessed: 2023 Jul. 31.
Tang, R.; Han, X.; Jiang, X.; and Hu, X. 2023. Does Synthetic Data Generation of LLMs Help Clinical Text Mining? arXiv: 2303.04360.
Thoppilan, R.; Freitas, D. D.; Hall, J.; Shazeer, N.; Kulshreshtha, A.; Cheng, H.; Jin, A.; Bos, T.; Baker, L.; Du, Y.; Li, Y.; Lee, H.; Zheng, H. S.; Ghafouri, A.; Menegali, M.; Huang, Y.; Krikun, M.; Lepikhin, D.; Qin, J.; Chen, D.; Xu, Y.; Chen, Z.; Roberts, A.; Bosma, M.; Zhou, Y.; Chang, C.; Krivokon, I.; Rusch, W.; Pickett, M.; Meier-Hellstern, K. S.; Morris, M. R.; Doshi, T.; Santos, R. D.; Duke, T.; Soraker, J.; Zevenbergen, B.; Prabhakaran, V.; Diaz, M.; Hutchinson, B.; Olson, K.; Molina, A.; Hoffman-John, E.; Lee, J.; Aroyo, L.; Rajakumar, R.; Butryna, A.; Lamm, M.; Kuzmina, V.; Fenton, J.; Cohen, A.; Bernstein, R.; Kurzweil, R.; y Arcas, B. A.; Cui, C.; Croak, M.; Chi, E. H.; and Le, Q. 2022. LaMDA: Language Models for Dialog Applications. CoRR, abs/2201.08239.
Vaughn, P. E. 2020. The effects of devaluation and solvability on crime clearance. Journal of Criminal Justice, 68.
Yang, B.; Yih, W.-t.; He, X.; Gao, J.; and Deng, L. 2015. Embedding Entities and Relations for Learning and Inference in Knowledge Bases. In 3rd International Conference on Learning Representations, ICLR 2015, San Diego, CA, USA, May 7-9, 2015, Conference Track Proceedings.
Zilka, M.; Butcher, B.; and Weller, A. 2022. A Survey and Datasheet Repository of Publicly Available US Criminal Justice Datasets. In Advances in Neural Information Processing Systems, volume 35, 28008-28022. Curran Associates, Inc.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented, artificial intelligence (AI) method for integrating fact-checked synthetic datasets with existing data to support AI-based decision making, the method comprising:
generating synthetic data using an automated few-shot prompting mechanism with a generative AI model, the automated few-shot prompting mechanism comprising:
feeding the generative AI model with a data schema of an existing database containing the existing data,
feeding the generative AI model with a query language description with an instruction to generate a query for a missing feature from a database containing ground truth information,
executing the generated query to obtain the ground truth information from the database for training the generative AI model, and
prompting the trained generative AI model to generate the synthetic data; and
integrating the generated synthetic data with the existing data in the existing database.

2. The method according to claim 1, wherein the automated few-shot prompting includes an iterative process to teach the generative AI model to determine semantic relations prior to generating the synthetic data, the iterative process comprising:
preprocessing the existing data to generate an incomplete record by removing a feature that is derivable from other features;
feeding the incomplete record to the generative AI model with an instruction to fill in the removed feature; and
training the generative AI model using feedback on whether the generative AI model provided a correct response to the instruction to fill in the removed feature.

3. The method according to claim 1, wherein the automated few-shot prompting mechanism includes an iterative process to teach the generative AI model to correctly generate the query prior to generating the synthetic data, the iterative process comprising:
passing the generated query to a query language parser; and
training the generative AI model using feedback on whether the generated query contains errors in query syntax.

4. The method according to claim 1, wherein the automated few-shot prompting mechanism includes instructing the generative AI model to provide an answer to the query and checking the answer for correctness by comparing the answer to the ground truth information, and wherein the training the generative AI model is performed by prompts that inform the generative model of the ground truth information in a case it is determined that the answer is different from the ground truth information.

5. The method according to claim 1, further comprising extending the existing database by extracting facts from text data sources using natural language processing techniques.

6. The method according to claim 1, further comprising enhancing connectivity of records in the existing database by geospatial linking.

7. The method according to claim 6, wherein the geospatial linking comprises:
computing a polygon around an event location based on a given network;
querying potential points of interest within the computed polygon to determine pairs of locations that are stored as key-value pairs in a key-value database;
computing a shortest path to a nearest neighbor based on the given network;
aggregating line segments of the given network into an aggregated value based on the shortest path; and
hashing the aggregated value and storing the hashed aggregated value as a key-value pair in the key-value database.

8. The method according to claim 7, wherein the polygon includes an additional buffer size for scalability to a new location located adjacent to the polygon.

9. The method according to claim 6, further comprising swapping data contained in the existing database between memory and persistent storage based on the geospatial linking such that subsequent queries involving geospatially linked locations are processable with a higher computational speed based on relevant data for the subsequent queries being stored in the memory.

10. The method according to claim 1, further comprising collecting information for building the existing database with the existing data from a sensor network, the sensor network including physical sensors that record information and virtual sensors that convert the recorded information to People, Objects, Locations, and Events of the data schema.

11. The method according to claim 10, wherein collecting the information for building the existing database includes querying the sensor network for the People, Objects, Locations and/or Events that are related to an entity of interest, and storing relationships determined by the querying in the existing database.

12. The method according to claim 1, further comprising using the existing database containing the synthetic data and the existing data to train an AI model for a downstream machine learning task.

13. The method according to claim 12, wherein the downstream machine learning task is a prediction of an area to be observed and/or resources to be allocated for public safety or disaster management, or wherein the downstream learning task is a medical prediction.

14. A computer, artificial intelligence (AI) system for integrating fact-checked synthetic datasets with existing data to support AI-based decision making, the system comprising one or more hardware processors which, alone or in combination, are configured to provide for execution of the following steps:
generating synthetic data using an automated few-shot prompting mechanism with a generative AI model, the automated few-shot prompting mechanism comprising:
feeding the generative AI model with a data schema of an existing database containing the existing data,
feeding the generative AI model with a query language description with an instruction to generate a query for a missing feature from a database containing ground truth information,
executing the generated query to obtain the ground truth information from the database for training the generative AI model, and
prompting the trained generative AI model to generate the synthetic data; and
integrating the generated synthetic data with the existing data in the existing database.

15. A tangible, non-transitory computer-readable medium for integrating fact-checked synthetic datasets with existing data to support AI-based decision making, the computer-readable medium having instructions thereon which, upon being executed by one or more hardware processors, alone or in combination, provide for execution of the following steps:
generating synthetic data using an automated few-shot prompting mechanism with a generative AI model, the automated few-shot prompting mechanism comprising:
feeding the generative AI model with a data schema of an existing database containing the existing data,
feeding the generative AI model with a query language description with an instruction to generate a query for a missing feature from the a database containing ground truth information, and
executing the generated query to obtain the ground truth information from the database for training the generative AI model, and
prompting the trained generative AI model to generate the synthetic data; and
integrating the generated synthetic data with the existing data in the existing database.
